(19) United States
(12) Patent Application Publication
(10) Pub. No.: US 2022/0097958 A1
(43) Pub. Date: Mar. 31, 2022

(54) WASTE MANAGEMENT BASED ON CONTEXT CONDITIONS

(71) Applicant: International Business Machines Corporation, Armonk, NY (US)

(72) Inventors: Gianluca Gargaro, Roma (IT); MATTEO ROGANTE, Rome (IT); Stefania Errore, Rome (IT); Maria Carmela Alesina, Rome (IT)

(21) Appl. No.: 17/034,471

(22) Filed: Sep. 28, 2020

(51) Int. Cl. B65F 1/14; G16Y 40/35; H04L 12/58; G16Y 40/60

(52) U.S. Cl. CPC B65F 1/14; G16Y 40/35; B65F 2210/176; G16Y 40/60; B65F 2210/1443; H04L 51/046

(57) ABSTRACT

In an aspect for waste management based on context conditions are provided, a method comprises receiving an indication of a waste item to be disposed by a person from a position thereof. One or more waste containers being suggested for disposing the waste item are selected according to the waste item, the position, filling indicators of the waste containers, and context conditions relating to the waste containers. A computer program product and computer system for performing the method are also proposed.

### BACKGROUND

The present invention relates generally to the field of information technology, and more specifically to the management of waste based on context conditions.

Waste is a critical issue in modern society. Indeed, the continuous economic and population growth globally has caused a corresponding increase of waste that is generated by human activity. This phenomenon is exacerbated by consumerism, which encourages the acquisition of goods in ever-increasing amounts. All of the above rises the generation of waste, in terms of unwanted/unusable materials that are disposed after their primary use, because defective or simply worthless. A typical example is Municipal Solid Waste (MSW), commonly known as trash, garbage or rubbish, which relates to the waste generated by persons in their private life (whose etymology derives from the traditional role of municipalities in the management thereof).

However, this enormous generation of waste is causing a rapid environmental degradation. Indeed, the waste may cause air, water, and soil pollution; moreover, the waste may cause depletion of resources, since more resources are extracted to produce goods than the earth is capable of replenish. This is harmful for the environment and it may be very dangerous for human health. Moreover, the management of waste (i.e., its collection, transport, treatment, and dumping) involves a high economic cost.

All of the above has brought about the understanding that global economic and population growth may not be sustained at current production and consumption rates. As a consequence, nowadays there is great emphasis in sustainability, aimed at balancing both the requirements of human needs and preservation of the environment. Sustainability expresses itself in several (green) programs intended to reduce the impact of the production and consumption of goods on the environment.

A key aspect of most green programs is the management of waste. Particularly, recycling allows converting waste into new objects by producing a fresh supply of the same raw material of the waste, using waste for the production of different products, or the salvage of valuable/hazardous components from complex products. This reduces the disposal of waste (and thus, air/water/soil pollution) and the consumption of raw materials (and thus, depletion of resources). Alternatively, waste may be reused for several purposes. Particularly, waste may be treated to generate energy. For example, modern technologies (such as pyrolysis, gasification, and plasma arc gasification) provide a power source that is clean and economical. Moreover biodegradable waste may be composted to decompose it into organic material, which may be used in agricultural applications.

However, the management of waste is a quite complex activity. Indeed, several aspects may adversely affect its performance.

Particularly, responsibility and education of persons play a key role in the collection of the waste. Indeed, not all persons are always available to sort the waste correctly (because of either poor ecological awareness or simply laziness). Moreover, sometimes it may be difficult for the persons to known how and where the waste should be disposed, especially when in public areas.

Optimization of the different activities involved in the management of waste is also very difficult. Indeed, this depends on several interrelated factors that are very often difficult to envisage. Particularly, the total cost of managing the waste significantly varies according to how it is collected from waste containers wherein it has been disposed, how it is transferred from the waste containers to larger transport vehicles, how it is transported to points of treatment, and how it is recycled, reused or dumped (such as in landfills).

### SUMMARY

Aspects of an embodiment of the present invention disclose a method, computer program product, and computer system for waste management based on context conditions. The method comprises receiving a corresponding plurality of current filling indicators of a plurality of waste containers from a corresponding plurality of sensing devices associated with the plurality of waste containers; providing a first indication of one or more context conditions relating to the plurality of waste containers; receiving a second indication of at least one waste item to be disposed by a person from a computing device of the person; providing a third indication of a current position of the person; determining one or more suggested waste containers of the plurality of waste containers for disposing the at least one waste item according to the at least one waste item, the current position, the corresponding plurality of current filling indicators, and the one or more context conditions; and returning a fourth indication of the one or more suggested waste containers to the computing device to cause an output thereof on the computing device.

### BRIEF DESCRIPTION OF THE DRAWINGS

FIG. 1A-FIG. 1D depict several aspects of a waste management environment, in accordance with several embodiments of the present invention;

FIG. 2 depicts a schematic block diagram of a computing infrastructure of the waste management environment, in accordance with an embodiment of the present invention;

FIG. 3 depicts software components of computing devices of the waste management environment, in accordance with an embodiment of the present invention; and

FIG. 4A-FIG. 4C depict a flowchart of the steps of a method for waste management based on context conditions, in accordance with an embodiment of the present invention.

### DETAILED DESCRIPTION

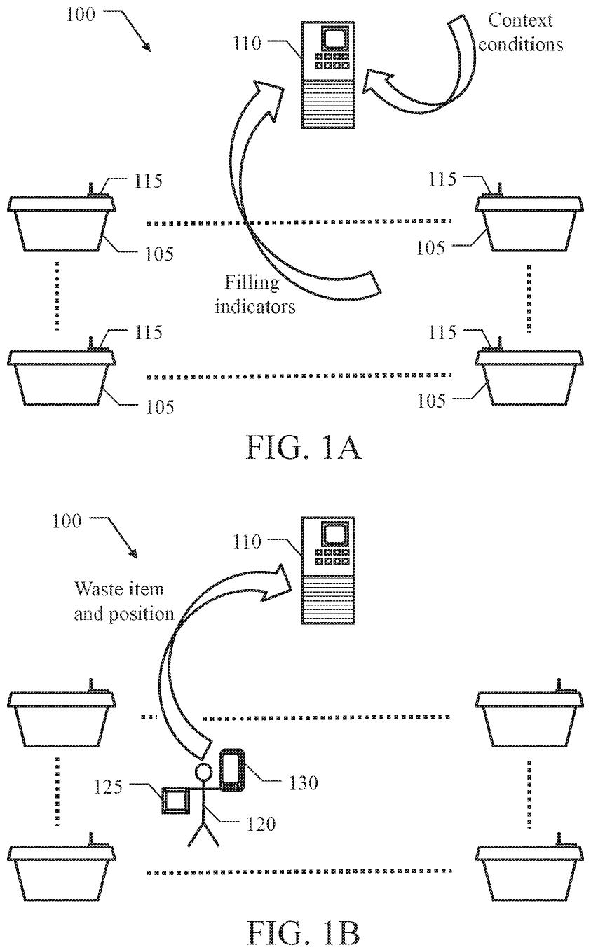

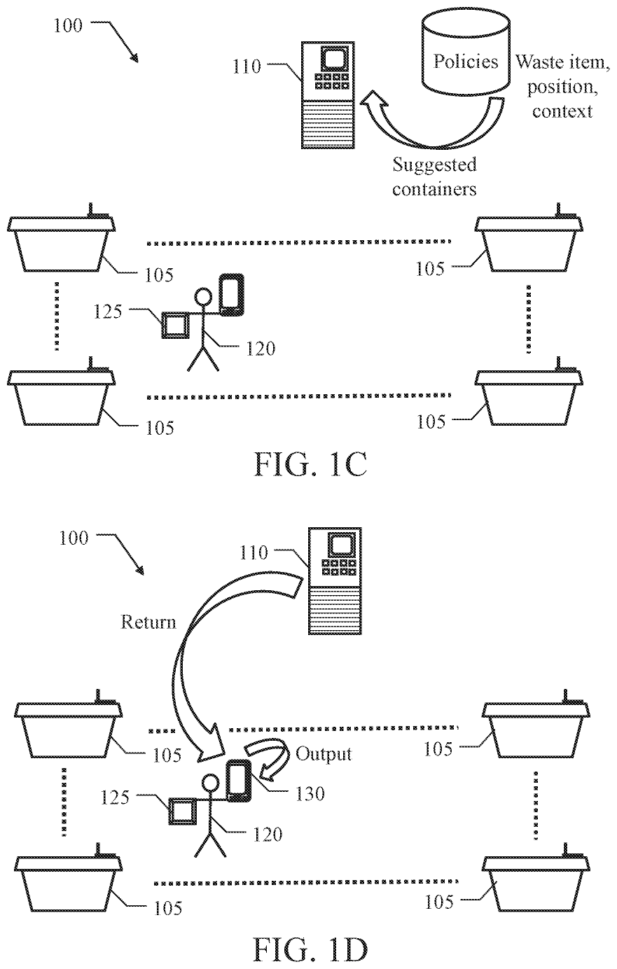

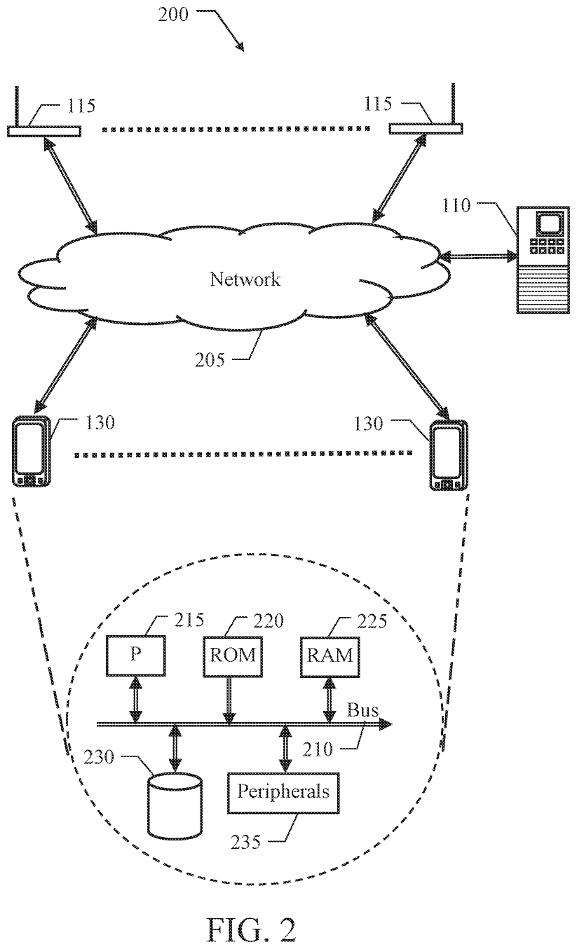

FIG. 1A-FIG. 1D depict several aspects of a waste management environment 100, in accordance with several embodiments of the present invention.

Starting from FIG. 1A, a plurality of waste containers 105 are distributed in a (managed) area that is managed by a corresponding organization (for example, a municipality). The waste containers 105 are used by persons (not shown) to dispose waste. The waste containers 105 are generally placed in public zones (for example, parks, streets, undergrounds, etc.). The waste containers 105 are intended to store the waste that is disposed by the persons temporarily, up to when it is transferred from the waste containers 105 to larger transport vehicles (such as trucks) for their transport to points of treatment (not shown). The waste may then be recycled (for converting it into new objects), reused (for generating energy or compost), or dumped (such as in landfills). For example, the waste containers 105 are bins, cans, baskets, and the like, either open or with lids closing them (operable manually or automatically), and so on. A computing system, for example, a server 110 of the organization in charge of managing the waste in the area (the municipality in the example at issue) is used to control the management of waste according to an embodiment of the present invention.

For this purpose, a sensing device 115 (for example, based on the Internet of Things (IoT) technology) is associated with each waste container 105, in which the sensing device 115 measures a filling of the waste container 105. The server 110 receives a current value of a filling indicator (current filling indicator) of each waste container 105 from its sensing device 115, in which the current filling indicator specifies a level of filling of the waste container 105 (as measured by the sensing device 115). Moreover, the server 110 is provided with an indication of one or more context conditions. The context conditions comprise any circumstances that affect the disposal of the waste in one or more zones of the managed area (up to its entirety); this applies globally at the level of the zones, i.e., for every person being there. Typical examples are mass events, such as a football match, in which the amount of waste that is disposed around a stadium where the football match takes place increases significantly before and after it. Other examples are hot temperatures (increasing disposal of plastic bottles of water), pandemic situations (increasing disposal of masks/gloves), and so on.

Moving to FIG. 1B, a generic person 120 needs to dispose a waste item (or more) 125. The person 120 has a computing device, for example, a smartphone 130. The person 120 uses the smartphone 130 to send an indication of the waste item to the server 110 (for example, determined by scanning a QRcode provided thereon). At the same time, the server 110 is also provided with a current value of a position (current position) of the person 120; for example, the smartphone 130 determines its position and transmits it to the server 110 together with the indication of the waste item.

Moving to FIG. 1C, the server 110 determines one or more (suggested) waste containers 105 to be suggested to the person 120 for disposing the waste item 125. The suggested waste containers 105 are determined according to the waste item 125, the current position of the person 120, the current filling indicators of the waste containers 105, and the context conditions (such as by applying one or more policies based thereon). For example, in everyday context conditions, the server 110 selects the (local) waste containers 105 (adapted to receive the waste item 125) that are close to the current position of the person 120. The suggested waste containers 105 may be ranked, for example, as a function of managing expenses for managing the waste disposed therein. Conversely, if the person is in a zone wherein a mass event is taking place or will take place shortly, it is preferable to avoid using the corresponding waste containers 105 because of the high amount of waste that is likely to be disposed therein before and after the mass event. In this case, in addition or in alternative the server 110 selects remote waste containers 105 that are farther away and then are likely to be not impacted by the mass event. The suggested waste containers 105 may be ranked by giving priority to the remote waste containers 105 with respect to the local waste containers 105. In any case, the server 110 may determine corresponding rewards for the person if they dispose the waste item into the suggested waste containers 105, for example, in terms of discounts on a waste fee decreasing with the ranking of the waste containers 105.

Moving to FIG. 1D, the server 110 returns an indication of the suggested waste containers 105 to the smartphone 130; for example, the suggested waste containers 105 are ordered according to their rewards. This information is then output on the smartphone 130. For example, a list of the suggested waste containers 105 is displayed in decreasing order of their rewards. In this way, the person 120 is incentivized to dispose the waste item 125 into one of the suggested waste containers 105, and particularly into the suggested waste container 105 providing the highest reward.

The above-mentioned embodiments significantly improve the performance of the management of waste.

Particularly, the proposed invention increases responsibility and education of the persons. Indeed, the persons now become fully aware of the impact of their behavior on the environmental degradation. This increases the ecological awareness of the persons and it may help overcoming their laziness. Moreover, the persons are now promptly informed about how and where the waste should be disposed.

This allows adapting the disposal of the waste dynamically according to contingent needs. Indeed, the determination and the possible ranking of the suggested waste containers takes into account the waste containers that are suitable to receive the waste, the capability of the suitable waste containers to receive further waste based on its current filling indicators, where the person is at the moment (based on their current position), and what is happening in that area (based on context conditions).

In this way, it is possible to avoid or at least significantly reduce the risk of saturating the waste containers. This is true not only on a day-by-day basis, but also in case of exceptional situations.

All of the above has a beneficial impact on the management of waste, and particularly on its total cost.

With reference now to FIG. 2, a schematic block diagram of computing infrastructure 200 of the waste management environment 100 is depicted, in accordance with an embodiment of the present invention.

The computing infrastructure 200 comprises the server 110, the sensing devices 115, and multiple instances of the smartphone 130. The server 110, the sensing devices 115, and the smartphones 130 communicate over a (telecommunication) network 205, for example, based on the Internet.

Each of the above-mentioned computing devices (i.e., the server 110, the sensing devices 115, and the smartphones 130) comprises several units that are connected among them through a bus structure 210 at one or more levels (with an architecture that is suitably scaled according to the type of the computing device). Particularly, a processor (P) 215, or more, provides a logic capability of the computing device; a non-volatile memory (ROM) 220 stores basic code for a bootstrap of the computing device, and a volatile memory (RAM) 225 is used as a working memory by the processor 215. The computing device is provided with a mass-memory 230 for storing programs and data (for example, storage devices of a data center wherein the server 110 is implemented and a flash memory for each sensing device 115 and smartphone 130). Moreover, the computing device comprises a number of controllers for peripherals, or Input/Output (I/O) units, 235. For example, the peripherals 235 of the server 110 comprise a network card for plugging the server 110 into the corresponding data center and then connecting it to a console of the data center for its control (for example, a personal computer, also provided with a drive for reading/writing removable storage units, such as of USB type) and to a switch/router sub-system of the data center for its communication with the network 205. The peripherals 235 of each sensing device 115 comprise a filling gauge for measuring an amount of waste contained in the corresponding waste container and then its filling (for example, based on a scale measuring a weight of the waste) and a mobile telephone transceiver (TX/RX) and/or a WNIC of the Wi-Fi type for accessing the network 205 (via a mobile telephone network and access points, respectively). The peripherals 235 of each smartphone 130 comprise a mobile telephone transceiver (TX/RX) for communicating with the mobile telephone network and a WNIC of the Wi-Fi type for communicating with access points (and then accessing the network 205), a scanner for scanning codes (such as QRcodes), a GPS receiver for detecting the position of the smartphone 130, and a touchscreen for entering commands/data and for displaying information.

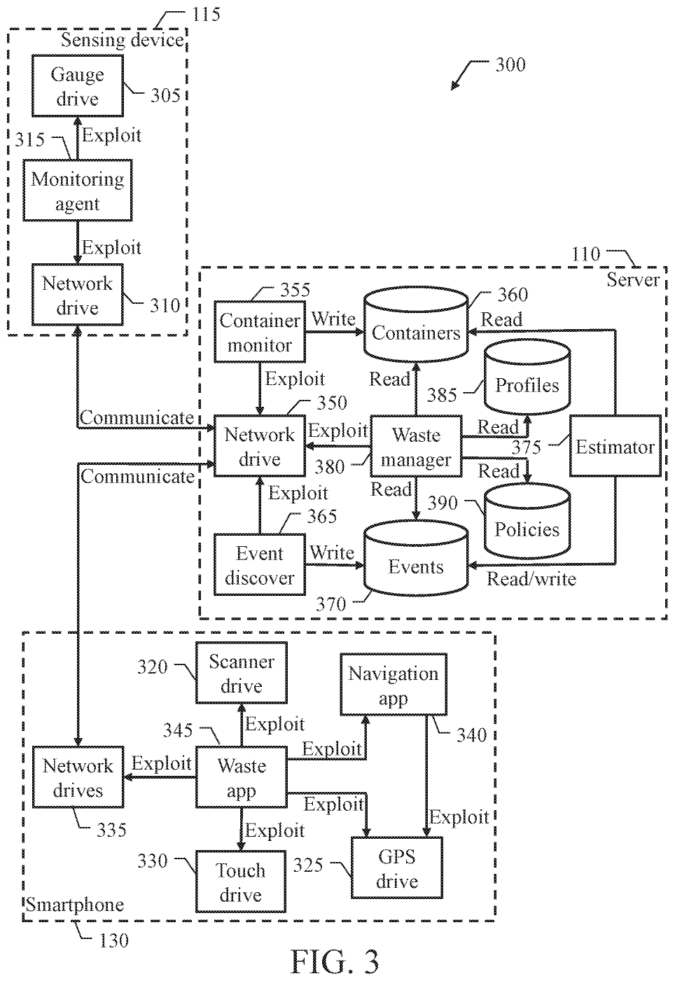

With reference now to FIG. 3, software components 300 of the computing devices of the waste management environment 100 are depicted, in accordance with an embodiment of the present invention.

Particularly, all the software components (programs and data) are denoted as a whole with the reference 300. The software components 300 are typically stored in the mass memory and loaded (at least partially) into the working memory of each computing device (i.e., the server 110, the sensing devices 115, and the smartphones 130) when the programs are running, together with an operating system and other application programs (not shown). The programs are initially installed into the mass memory, for example, from removable storage units or from the network. In this respect, each program may be a module, segment or portion of code, which comprises one or more executable instructions for implementing the specified logical function.

Starting from each sensing device 115 (only one shown in FIG. 3), it comprises the following software components.

A gauge drive 305 drives the filling gauge and a network drive 310 (or more) drives the mobile telephone transceiver and/or the WNIC. A monitoring agent 315 monitors the filling of the corresponding waste container. The monitoring agent 315 exploits the gauge drive 305 to measure the filling of the waste container and the network drive 310 to transmit the current filling indicator to the server 110, for example, expressed in percentage with respect to a capacity of the waste container.

Moving to each smartphone 130 (only one shown in FIG. 3), it comprises the following software components.

A scanner drive 320 drives the scanner, a GPS drive 325 drives the GPS receiver, a touch-screen drive 330 drives the touch-screen and corresponding network drives 335 drive the mobile telephone transceiver and the WNIC. A navigation app 340 is used to guide the person towards selected destinations through corresponding (optimized) routes. For this purpose, the navigation app 340 exploits the GPS drive 340 to track the position of the smartphone 130. A waste app 345 is used to control the disposal of waste by the corresponding person. The waste app 345 exploits the scanner drive 320 and/or the touch-screen drive 330 to determine each waste item to be disposed, the GPS drive 325 to determine the current position of the smartphone 130 and then of the person, and possibly the navigation app 340 to determine the (current) route of the person. Moreover, the waste app 345 exploits the network drives 335 to submit (disposal) requests for disposing waste to the server 110, to receive corresponding (disposal) responses therefrom, and the touch-screen drive 330 to select the suggested waste containers to be used to dispose each waste item.

As in FIG. 3, the server 110 comprises the following components.

A network drive 350 drives the network card for communicating with the network drives 310 of all the sensing devices 115 and with the network drives 335 of all the smartphones 130. A container monitor 355 monitors the filling of the waste containers. For this purpose, the container monitor 355 exploits the network drive 350 to collect the current filling indicators of the waste containers. The container monitor 355 writes a container repository 360, which specifies all the waste containers in the management area. For example, the container repository 360 has an entry for each waste container. The entry stores a location of the waste container, for example, its GPS coordinates, also acting as unique identifier thereof, a type of the waste to be disposed in the waste container, managing expenses for managing the waste disposed in the waste container (for example, per unit of weight for its transport to the corresponding points of treatment and for its recycling, reuse or dumping), and the capacity of the waste container (for example, maximum weight of waste that may be contained therein).

This information is set at an installation of the waste container and it may be updated later on following a change of the management of waste. The entry stores a list of previous values of an emptying time (previous emptying times) of the waste container (for example, in the last 6-24 months) and a next value of the emptying time (next emptying time), such as with the last one imported from a collection plan of the waste (for example, on a daily base). The entry stores a list of previous values of the filling indicator (previous filling indicators) of the container (for example, in the last 6-24 months), with the last one that may be considered as the current value of the filling indicator (current filling indicator) with an acceptable degree of accuracy.

An event discoverer 365 discovers mass events that are planned to take place in the future in the management area (or close to it). For this purpose, the event discoverer 365 exploits the network drive 350 to interact with one or more external services, for example, news, bulletin boards, social networks, and the like services. The event discoverer 365 writes an event repository 370, which specifies the events that have taken place in the past, the events that are in progress at the moment and the events that will take place in the future. For example, the event repository 370 has an entry for each (past/present/future) event; the entry stores a type of the mass event (for example, football match, music concert, exposition, congress, theater performance, etc.), the location of the mass event (for example, GPS coordinates of its venue), and a time of the event (for example, event start time and event end time). The entry stores an impact time of a possible impact of the mass event on the waste containers (for example, impact start time and impact end time). The impact start time precedes the event start time and the impact end time follows the event start time to take into account the impact of the persons reaching and leaving, respectively, the location of the mass event. The event repository 370 also indicates an impact of the mass events on the waste containers, being actual for the past/present and estimated for the future. For example, the entry of each mass event contains a list of any waste containers that are impacted by the mass event; for each impacted waste container, the list stores its location together with an increase of its filling due to the mass event (for example, additional percentage of its capacity).

An estimator 375 estimates the impact of the mass events on the waste containers in the future. The estimator 375 reads the container repository 360 and reads/writes the event repository 370. A waste manager 380 manages the disposal of the waste by the persons into the waste containers. The waste manager 380 exploits the network drive 350 to receive the disposal requests and to the return the corresponding disposal responses. The waste manager 380 reads the container repository 360, the mass event repository 370, a profile repository 385, and a policy repository 390.

The profile repository 385 contains profiles of the persons that are registered with the management organization (such as residents of the municipality), provided that they have given the required authorizations. For example, the profile of each person stores identification information (such as name and address), authentication information (such as userId and password), a score (such as from 0 to 100 in increasing order of responsible behavior of the person over time), and a credit (such as indicative of the total rewards awarded to the person in the current year). Moreover, the profile may also store previous values of the position (previous positions) of the person (such as in the last 6-12 months) and an indication of one or more recurrent routes of the person. For example, each recurrent route is defined by the GPS coordinates of its waypoints (from an origin to a destination thereof) and its recurring time, such as every working day at 8:00 AM and 5:00 PM).

The policy repository 390 contains one or more policies for evaluating the disposal of waste by the persons. The policies define a (disposal) value for the disposal of any waste item, either positive (utility/fitness) or negative (cost/loss), which disposal value should be optimized (i.e., maximized if positive or minimized if negative). The disposal value is a function of the waste type of the waste item to be disposed (for example, material, size, weight, etc.), the management expenses of the waste container that is used to dispose it, its current filling indicator, the current position and possibly the current route of the person, the context conditions relating to the disposal (i.e., the possible impact of the mass events on the filling of the waste containers in the example at issue), and the profile of the person. For this purpose, the policy may also use contract information (such as leveraging a smart contract stored in a blockchain) to determine the disposal value based on a selling price of the material of the waste item. For example, the contract information may determine the disposal value of an aluminum can based on the selling price the municipality has achieved with companies that produce aluminum, also updated according to a current level of aluminum in a storage system of the municipality. The policies determine the disposal value by giving priority to waste containers (suitable for the waste item) with lower management expenses and to the waste containers with lower filling indicators, increased to take into account their possible overloading due to mass events taking place close to them. The policies further incentivize the use of better waste containers (i.e., with lower management expenses and/or (possibly increased) filling indicators), even if they are more far away from the current position of the person (or from its current route) than other waste containers. The result of the evaluation of the policies is then an assessment of the value of the disposal of the waste item. This disposal value may be considered a reward to be awarded to the persons if positive, whereas it may be considered a cost to be paid by the persons if negative.

All of the above induces the persons to develop and maintain a persistent responsible behavior over time, for example, because using the waste containers providing corresponding rewards reduces the waste fees that the persons have to pay to the municipality.

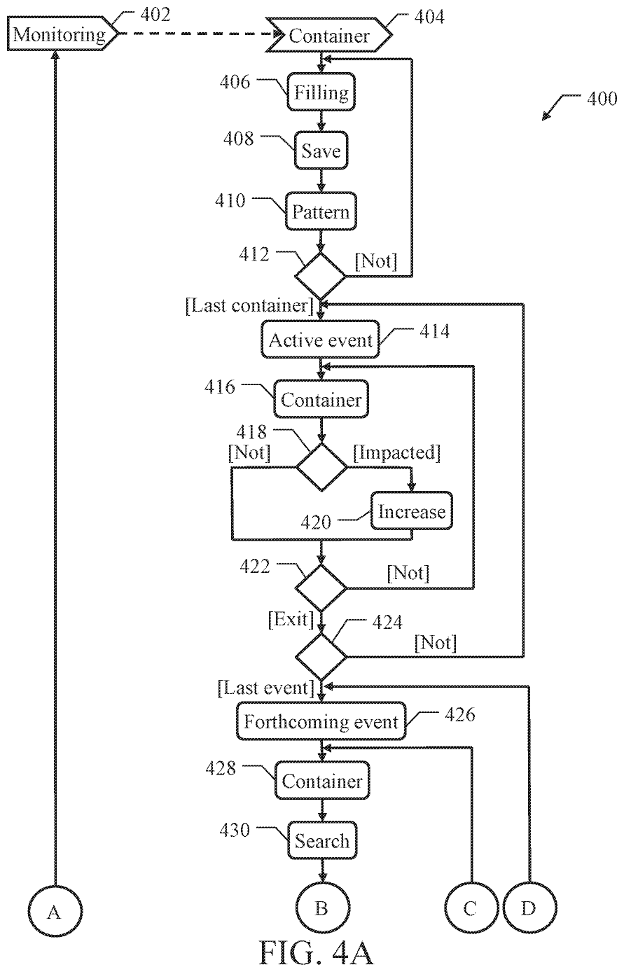

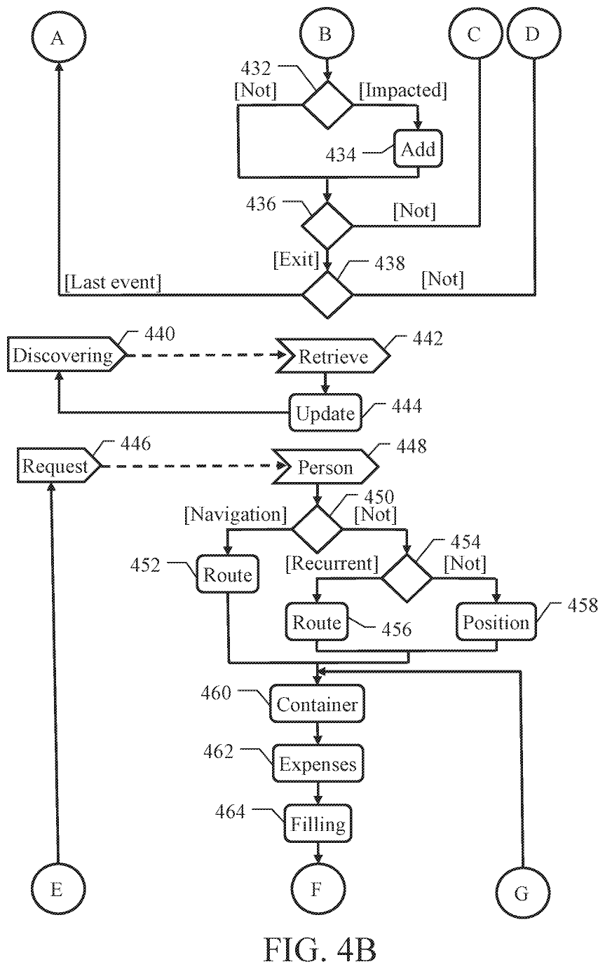

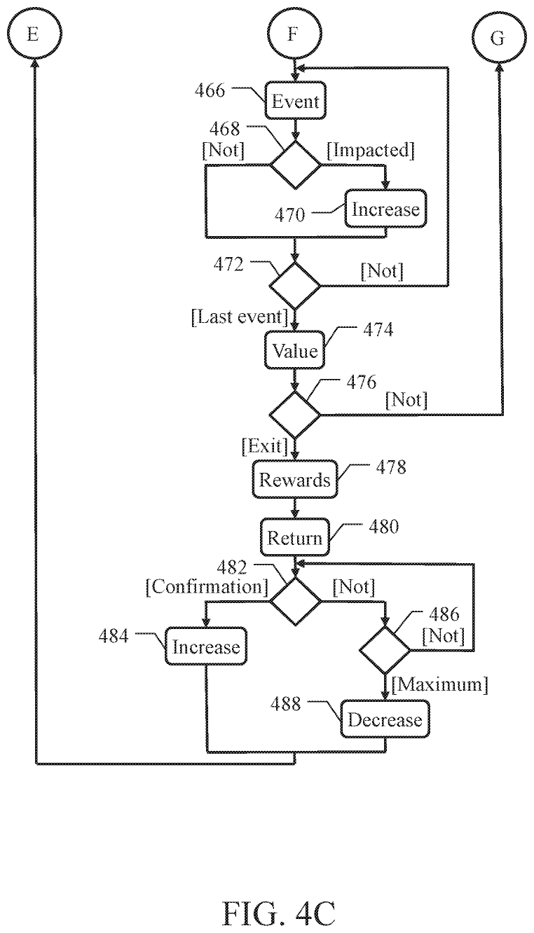

With reference now to FIG. 4A-FIG. 4C, a flowchart diagram of the steps of method 400 for waste management based on context conditions is depicted, in accordance with an embodiment of the present invention. In this respect, each block may correspond to one or more executable instructions for implementing the specified logical function on a generic server. Particularly, the diagram represents an exemplary process that may be used to manage the disposal of waste with method 400.

The process passes from block 402 to block 404 as soon as an event occurs triggering the monitoring of the waste containers (for example, periodically such as every 5-10 minutes). In response thereto, a loop is entered wherein the container monitor takes a (current) container into account, starting from a first one in any arbitrary order. The container monitor at block 406 collects the current filling indicator of the container by sending a corresponding request to the collector agent of the corresponding sensing device and receiving a response thereto via the respective network drives. The container monitor at block 408 saves the current filling indicator into the container repository.

The estimator at block 410 determines a filling pattern of the waste container and saves it into a corresponding variable according to the (historical) information stored in the container repository for the waste container. Particularly, the estimator determines a normal value of the filling indicator (normal filling indicator) at the time. For example, the estimator calculates the elapsed time from the last value of the emptying time (last emptying time). The estimator extracts the (matching) previous filling indicators at the times following the previous emptying times by the same elapsed time. The estimator calculates the normal filling indicator as an average of the matching previous filling indicators (by discarding possible outliers that might be due to previous mass events). Moreover, the estimator determines a maximum value of the filling indicator (maximum filling indicator) just before the next emptying time. For example, the estimator extracts the (maximum) previous filling indicators just before the previous emptying times; for each previous emptying time, the estimator calculates a filling rate as a difference between the corresponding maximum previous filling indicator and matching previous filling indicator. The estimator calculates an average of the filling rates by discarding possible outliers that might be due to previous mass events. The estimator calculates the maximum filling indicator by adding the average of the filling rates to the current filling rate.

The container monitor at block 412 verifies whether a last waste container has been processed. If not, the flow of activity returns to the block 406 to repeat the same operations on a next waste container. Conversely, once all the waste containers have been processed, the loop is exit by descending into block 414.

At this point, a loop is entered for determining the possible impact of the (active) mass events that might impact the waste containers; the active mass events are the ones whose impact start time is already elapsed but whose impact end time is not elapsed yet. The loop begins with the estimator that takes a (current) active mass event into account, starting from a first one in any arbitrary order.

A further loop is entered at block 416 for verifying the filling of the waste containers around the location of the active mass event. The loop begins with the estimator that takes a (current) waste container into account, in increasing order of distance of the locations of the waste containers from the location of the active mass event, starting from the closest one as indicated in the corresponding repositories. The estimator at block 418 compares the current filling indicator and the normal filling indicator of the waste container. If the current filling indicator is significantly higher than the normal filling indicator (for example, by more than 20-30%), this means that the waste container is likely to have been impacted by the active mass event. In this case, the estimator at block 420 calculates the filling increase of the waste container (due to the active mass event) as the difference between the current filling indicator and the normal filling indicator. The estimator adds the waste container (i.e., its location) and the corresponding filling increase to the list of the impacted waste containers of the active mass event in the corresponding repository.

The process then descends into block 422; the same point is also reached directly from the block 418 if the current filling indicator is not significantly higher than the current filling indicator (i.e., the waste container is likely to have been not impacted by the active mass event). At this point, the estimator verifies whether an exit condition of the loop for verifying the waste containers is satisfied. For example, this happens as soon a predefined number (such as 1-3) of waste containers that are not impacted by the active mass event has been found. If not, the flow of activity returns to the block 416 to repeat the same operations on a next waste container whose location is farther away from the location of the active mass event.

Conversely, once the exit condition is satisfied, the loop is exited by descending into block 424. The estimator now verifies whether a last active mass event has been processed. If not, the flow of activity returns to the block 414 to repeat the same operations on a next active mass event. Conversely, once all the active mass events have been processed, the loop is exited by descending into block 426.

At this point, a loop is entered for estimating the possible impact on the waste containers in the future of the (forthcoming) mass events, for example, which are in progress or will start before the last next emptying time of all the waste containers. The loop begins with the estimator that takes a (current) forthcoming mass event into account, starting from a first one in any arbitrary order. A further loop is entered at block 428 for verifying the possible impact of the forthcoming mass event on the waste containers around its location. The loop begins with the estimator that takes a (current) waste container into account, in increasing order of distance of the locations of the waste containers from the location of the forthcoming mass event, starting from the closest one as indicated in the corresponding repositories. The estimator at block 430 searches the waste container (i.e., its location) in the list of impacted waste containers of the previous mass events of the same type as the forthcoming mass event in the corresponding repository. The flow of activity branches at block 432 according to a result of the search. If the location of the waste container has been found in the lists of impacted waste containers of one or more previous mass events, this means that waste container is likely to be impacted by the forthcoming mass event as well. In this case, the estimator at block 434 determines the filling increase of the waste container likely to be caused by the forthcoming mass event according to the filling increases of the waste container of these previous mass events, for example, equal to the maximum value thereof up to the next emptying time of the waste container. The estimator then adds the waste container (i.e., its location) and the corresponding filling increase to the list of the impacted waste containers of the forthcoming mass event in the corresponding repository.

The process then descends into block 436; the same point is also reached directly form the block 432 if the waste container has not been found in any list of impacted waste containers of the previous mass events (i.e., the waste container is likely to be not impacted by the forthcoming mass event). At this point, the estimator verifies whether an exit condition of the loop for verifying the waste containers is satisfied. For example, this happens as soon as predefined number (such as 1-3) of waste containers that are not impacted by the forthcoming mass event has been found. If not, the flow of activity returns to the block 428 to repeat the same operations on a next waste container whose location is farther away from the location of the forthcoming mass event. Conversely, once the exit condition is satisfied, the loop is exit by descending into block 438. The estimator now verifies whether a last forthcoming mass event has been processed. If not, the flow of activity returns to the block 426 to repeat the same operations on a next forthcoming mass event. Conversely, once all the forthcoming mass events have been processed, the loop is exit and the process returns to the block 402 waiting for a next monitoring event. The information so determined about the impact of the forthcoming mass events on the waste containers may also be used by the management organization to adapt the collection of the waste in advance to cope with its increase, for example, by intensifying the collection of the waste, the cleaning of the streets and so on.

In addition, the process passes from block 440 to block 442 as soon as a discovering event occurs triggering the discovering of the future mass events, for example, periodically such as every 1-2 days or whenever a corresponding notification is received. In response thereto, the event discover determines any (new/updated) mass event that has been planned to take place in the future. Particularly, the event discover may receive corresponding information in pull mode by submitting queries to the external services which return corresponding responses or in push mode from the external services to which the server has subscribed. For example, this information indicates the locations and the event start/end times of mass events that have been advertised in news services, published in bulletin boards, or posted in social networks. The event discover at block 444 determines the impact start/end times of each mass event, for example, by subtracting and adding, respectively, an (impact) period that may be either fixed (such as 1-2 hours) or variable according to the type of the mass event as defined in corresponding configuration information. The event discover updates the event repository accordingly. The process then returns to the block 440 waiting for a next discovering event.

Whenever any person needs to dispose a waste item (or more), they log into the waste app of the corresponding smartphone by authenticating with their userId and password. The person then scans a QRcode available on the waste item, from which the waste app determines its waste type, or the person selects the waste type manually from a corresponding menu of the waste app. For example, the waste item may be a bottle, a can, a newspaper, a leaflet, a food container, a product package, and so on. The waste app retrieves the current position of the smartphone (and therefore, of the person) from the GPS drive and the possible current route of the person from the navigation app (if active). In response to a confirmation command entered by the person, the waste app builds a disposal request indicating the waste type, the current position, and the possible current route of the person; and it submits the disposal request tagged with the userId of the person to the server via the network drive.

The process passes from block 446 to block 448 whenever the waste manager receives a disposal request from the waste app of the smartphone of any person via the network drive. In response thereto, the waste manager determines the person who has submitted the disposal request from its userId as indicated in the profile repository. The flow of activity branches at block 450 according to the content of the disposal request. If the disposal request contains the current route of the person who is guided by the navigation app along it, the waste manager at block 452 sets a start position, for searching the waste containers to be used to dispose the waste item, to the current route. Conversely, the waste manager at block 454 verifies whether the profile of the person contains the indication of a recurrent route matching the current position and the current time. If so, this means that the person is likely to be travelling along the recurrent route; for example, this happens for a recurrent route defined by every working day at 8:00 AM if the current position at 8:15 AM on a Monday is compatible with the position after 15 minutes along the recurrent route from its origin. In this case, the waste manager at block 456 sets the start position according to the recurrent route, i.e., to a remaining part thereof from the current position to its destination. Referring back to the block 454, if instead the profile of the person does not contain the indication of any recurrent route matching the current position and the current time, the waste manager at block 458 sets the start position to the current position.

The method 400 merges again at block 460 from the block 452, the block 454, or the block 456. At this point, a loop is entered for determining the suggested waste containers to be used for disposing the waste item. The loop begins when the waste manager that takes a (current) waste container into account, in increasing order of distance of the locations of the waste containers from the start position of the person, starting from the closest one as indicated in the corresponding repositories. The waste manager at block 462 retrieves the managing expenses for managing the waste disposed in the waste container from the corresponding repository. The waste manager at block 464 retrieves a maximum value of the filling indicator (maximum filling indicator) of the waste container just before its next emptying time from the corresponding variable.

A loop is then entered at block 466 for verifying the possible impact on the waste container of corresponding (forthcoming) mass events that are in progress or will start before the next emptying time of the waste container. The loop begins with the waste manager that takes a (current) forthcoming mass event into account, starting from a first one in any arbitrary order. The flow of activity branches at block 468 according to the list of impacted waste containers of the forthcoming mass event as indicated in the corresponding repository. If the waste container (i.e., its location) is comprised in the list of impacted waste containers of the forthcoming mass event, the waste manager at block 470 increases the maximum filling indicator according to the filling increases of the waste container caused by the forthcoming mass event, for example, by the maximum value thereof up to the next emptying time of the waste container retrieved from the corresponding repository. The process then descends into block 472; the same point is also reached directly from the block 468 if the waste container is not comprised in the list of impacted waste containers of the forthcoming mass event. At this point, the estimator verifies whether a last forthcoming mass event has been processed. If not, the flow of activity returns to the block 466 to repeat the same operations on a next forthcoming mass event. Conversely, once all the forthcoming mass events have been processed, the loop is exit by descending into block 474.

The waste manager now calculates the disposal value of the disposal of the waste item into the waste container by applying the policies, retrieved from the corresponding repository, to the waste type, its managing expenses, the start position of the person, and the (possibly increased) maximum filling indicator of the waste container. The waste manager at block 476 verifies whether an exit condition of the loop for determining the suggested waste containers is satisfied. For example, this happens as soon a predefined number (such as 1-3) of suggested waste containers having a disposal value higher than a threshold has been found or in any case after a maximum distance from the start position of the person has been reached. If not, the flow of activity returns to the block 460 to repeat the same operations on a next waste container whose location is farther away from the start position of the person. Conversely, once the exit condition is satisfied, the loop is exit by descending into block 478.

At this point, the waste manager determines a reward to be awarded to the person for using each suggested waste container. The reward depends on the corresponding disposal value and on the score of the person, for example, directly proportional thereto. This creates a virtuous spiral, with the higher the score the higher the reward and then the higher the likelihood of increasing the responsible behavior of the person. For example, the reward may be economic (such as a discount on the waste fees, a store credit, a gift voucher and the like) or reputational (such as for a personal rate, a ranking and the like). The waste manager at block 480 builds the disposal response to the disposal request. The disposal response comprises a list of the suggested waste containers (i.e., their locations) together with the corresponding rewards in decreasing order thereof. The waste manager returns the disposal response to the smartphone from which the disposal request has been received via the corresponding network drives.

In response thereto, the waste app displays an indication of the list of suggested waste containers on the touchscreen of the smartphone. For example, the waste app may display a map with an indication of the current position and the possible current route (via the GPS drive and the navigation app, respectively). The suggested waste containers are shown on the map together with their rewards. The person may then select one of the suggested waste container. In response thereto, the waste app commands the navigation app to guide the person towards the location of this selected (suggested) waste container. Once the person has reached the selected waste container and has disposed the waste item into it (for example, as inferred by the current position matching the location of the selected waste container, such as with their difference lower than 1-10 m), the waste app sends a corresponding disposal confirmation to the server via the corresponding network drives. The disposal confirmation indicates the selected waste container (i.e., its location).

In the meanwhile, the waste manager enters an idle loop at block 482, waiting for the disposal confirmation from the smartphone. As soon as the disposal confirmation is received, the waste manager at block 484 assigns the reward of the selected waste container to the person in the profile repository, for example, by increasing their credit accordingly. Moreover, the waste manager updates the score of the person accordingly in the profile repository, for example, by increasing it by a percentage equal to a fraction of the reward (such as 1-5%). The process then returns to the block 446 waiting for a next disposal request. Referring back to the block 482, if the disposal confirmation has not been received, the waste manager at block 486 verifies whether a maximum waiting time has been reached (for example, equal to a predetermined multiple, such as 1.5-3 times, of an estimated time for reaching the most far away suggested waste container from the start position). If not, the process returns to the block 482 to repeat the same operations. Conversely, once the maximum waiting time has been reached without receiving any disposal confirmation, it is likely that the person has not disposed the waste item in any suggested waste container. In this case, the waste manager at block 488 updates the score of the person accordingly in the corresponding repository, for example, decreasing it by a pre-defined percentage (such as 1-5%). The process then returns to the block 446 waiting for a next disposal request.

Naturally, in order to satisfy local and specific requirements, a person skilled in the art may apply many logical and/or physical modifications and alterations to the present invention. More specifically, although this invention has been described with a certain degree of particularity with reference to one or more embodiments thereof, it should be understood that various omissions, substitutions and changes in the form and details as well as other embodiments are possible. Particularly, different embodiments of the present invention may be practiced even without the specific details (such as the numerical values) set forth in the preceding description to provide a more thorough understanding thereof. Conversely, well-known features may have been omitted or simplified in order not to obscure the description with unnecessary particulars. Moreover, it is expressly intended that specific elements and/or method steps described in connection with any embodiment of the present invention may be incorporated in any other embodiment as a matter of general design choice. Moreover, items presented in a same group and different embodiments, examples or alternatives are not to be construed as de facto equivalent to each other, but they are separate and autonomous entities. In any case, each numerical value should be read as modified according to applicable tolerances; particularly, unless otherwise indicated, the terms “substantially”, “about”, “approximately” and the like should be understood as within 10%, preferably 5% and still more preferably 1%. Moreover, each range of numerical values should be intended as expressly specifying any possible number along the continuum within the range (comprising its end points). Ordinal or other qualifiers are merely used as labels to distinguish elements with the same name but do not by themselves connote any priority, precedence or order. The terms include, comprise, have, contain, involve and the like should be intended with an open, non-exhaustive meaning (i.e., not limited to the recited items), the terms based on, dependent on, according to, function of and the like should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a method for managing waste. However, the method may be applied to manage the waste in any contexts (for example, public areas, private premises, and so on).

In an embodiment, the method comprises the following steps under the control of a computing system. However, the computing system may be of any type (see below).

In an embodiment, the method comprises receiving a corresponding plurality of current filling indicators of a plurality of waste containers. However, the waste containers may be of any type (for example, of partial, different and additional types with respect to the ones mentioned above, either individually or in any combination thereof) and the filling indicators may have any value (for example, percentage, weight, volume, and so on). Moreover, the filling indicators may be received in any way (for example, in push mode, in pull mode, periodically, in response to any change, and so on).

In an embodiment, the current filling indicators are received from a corresponding plurality of sensing devices associated with the waste containers. However, the sensing devices may be of any type (for example, of mechanical, optical, magnetic and the like type, for measuring a weight, a volume and the like of the waste, and so on).

In an embodiment, the method comprises providing an indication of one or more context conditions relating to the waste containers. However, the context conditions may be in any number and of any type (for example, mass events, wheatear conditions, environment temperature, pandemic situations, and so on) and they may be provided in any way (for example, from partial, different and additional sources with respect to the ones mentioned above, either individually or in any combination thereof, in push more, in pull mode, periodically, in response to any change, and so on).

In an embodiment, the method comprises receiving an indication of at least one waste item to be disposed by a person. However, the waste items may be in any number and of any type (for example, of partial, different and additional types with respect to the ones mentioned above, either individually or in any combination) and each one may be indicated in any way (for example, by its waste type, weight, volume, and so on).

In an embodiment, the indication of the waste item is received from a computing device of the person. However, the computing device may be of any type (for example, a smartphone, a tablet, a netbook, and so on) and it may determine the waste item in any way (for example, by reading an optical code, reading an RFID tag, receiving a manual selection, recognizing a vocal command, recognizing an image of the waste item acquired with a camera, and so on).

In an embodiment, the method comprises providing an indication of a current position of the person. However, the position may be defined in any way (for example, by GPS coordinates, geographical coordinates, location, and so on) and it may be provided in any way (for example, received from the computing device that has detected it in any way, such as by a GPS receiver, according to cells of the mobile telephone networks in use and the like, inferred by the computing system according to the previous positions of the person, and so on).

In an embodiment, the method comprises determining suggested one or more of the waste containers for disposing the waste item according to the waste item, the current position, the current filling indicators, and the context conditions. However, the suggested waste containers may be determined in any number (for example, until one or more acceptable waste containers are found having a disposal value higher than a threshold, up to a maximum number, up to a maximum distance from the start position of the person, and so on) and in any way (for example, according to one or more policies defined explicitly, by a neural network suitably trained, and so on).

In an embodiment, the method comprises returning an indication of the suggested waste containers to the computing device to cause an output thereof on the computing device. However, the suggested waste containers may be indicated in any way (for example, in a list, on a map, and so on) and they may be output in any way (for example, displayed, uttered, all together or in succession, and so on).

Further embodiments provide additional advantageous features, which may however be omitted at all in a basic implementation.

Particularly, in an embodiment the method comprises receiving, by the computing system, a schedule of one or more mass events. However, the mass events may be in any number and of any type (for example, of partial, different and additional types with respect to the ones mentioned above, either individually or in any combination thereof).

In an embodiment, the method comprises defining the context conditions according to the mass events. However, the context conditions may be defined in any way according to the mass events (for example, according to their type, number of participants, and so on).

In an embodiment, the method comprises storing one or more previous filling indicators of each of the waste containers. However, the previous filling indicators may be stored in any way (for example, locally or remotely, for any period of time, and so on).

In an embodiment, the method comprises determining a corresponding plurality of normal filling indicators of the waste containers according to the corresponding previous filling indicators. However, the normal filling indicator of each waste container may be determined in any way according to its previous filling indicators (for example, as their average, median, mode and the like, with or without removing any outliers, and so on).

In an embodiment, the method comprises determining corresponding filling increases of any impacted ones of the waste containers being impacted by each active one of the context conditions. However, the active context conditions may be of any type (for example, mass events that are in progress, with or without the mass events that will start shortly and/or have finished shortly according to any fixed/variable period of time, and so on).

In an embodiment, the filling increases of the impacted waste containers are determined according to a comparison between the corresponding current filling indicators and normal filling indicators. However, the impacted waste containers may be determined in any way (for example, when the current filling indicator exceeds the normal filling indicator by any threshold, when this happens for one or more times, and so on).

In an embodiment, the method comprises storing the filling increases of the impacted waste containers of each previous one of the context conditions. However, the filling increases of the impacted waste containers may be stored in any way (for example, locally or remotely, for any period of time, for each context condition or for each type of context conditions, and so on).

In an embodiment, the method comprises estimating corresponding filling increases of any impacted ones of the waste containers to be impacted by each forthcoming one of the context conditions according to the filling increases of the impacted waste containers of the previous context conditions. However, the forthcoming context conditions may be of any type (for example, mass events that will start in the future with or without the mass events that are in progress, and so on) and their filling increases may be estimated in any way according to the filling increases of the corresponding previous context conditions (for example, according to their sum, average, maximum, up to the corresponding next emptying times or in general, and so on).

In an embodiment, the method comprises determining the suggested waste containers according to the current filling indicators of the waste containers being updated according to the filling increases of the impacted waste containers of the forthcoming context conditions. However, the current filling indicator of each impacted waste container may be updated in any way according to the filling increases of the forthcoming context conditions (for example, by adding their maximum, average and the like up to the next emptying time of the impacted waste container, up to the impact/event end time of the forthcoming mass event, and so on).

In an embodiment, the method comprises providing a current route of the person. However, the current route may be defined in any way (for example, by its waypoints, by its origin/destination, and so on) and it may be provided in any way (for example, received from the computing device, inferred by the computing system according to the previous positions of the person, and so on).

In an embodiment, the method comprises determining the suggested waste containers further according to the current route. However, the suggested waste containers may be determined in any way according to the current route (for example, by taking into account the waste containers around the route, along the route, and so on).

In an embodiment, the method comprises receiving the current route from a navigation application of the computing device. However, the current route may be received in any way (for example, only when the disposal requests are submitted, whenever the navigation application is used, and so on).

In an embodiment, the method comprises storing a plurality of previous positions of the person. However, the previous positions may be stored in any way (for example, locally or remotely, for any period of time, and so on).

In an embodiment, the method comprises determining one or more recurrent routes of the person according to the previous positions. However, the recurrent routes may be determined in any way (for example, when their repetition reaches a threshold, with pattern recognition techniques, and so on).

In an embodiment, the method comprises estimating the current route according to the recurrent routes. However, the current route may be estimated according to the recurrent routes in any way (for example, automatically, requiring a confirmation of the person, and so on).

In an embodiment, the method comprises storing a profile of the person. However, the profile may be stored in any way (for example, locally or remotely, and so on) and it may comprise any information of the person (for example, their score, fee rate, and so on).

In an embodiment, the method comprises determining the suggested waste containers further according to the profile. However, the suggested waste containers may be determined in any way according to the profile (for example, increasing the rewards with the score, biasing the person to use better waste containers that are more far away if the score is higher than a threshold, and so on).

In an embodiment, the method comprises receiving an indication of a disposal of the waste item into a selected waste container of the suggested waste containers from the computing device. However, the person may select the suggested waste container in any way (for example, from the list or the map, by refusing the suggested waste containers provided in succession up to the selected one, and so on). Moreover, the disposal of the waste item may be detected in any way (for example, when the position of the person matches the location of the selected waste container, in response to a manual command confirmed by reading the optical code or the RFID tag of the waste item in the selected waste container, and so on).

In an embodiment, the method comprises updating the profile according to the disposal of the waste item. However, the profile may be updated in any way according to the disposal of the waste item (for example, by awarding a corresponding reward, by updating the score of the person, and so on).

In an embodiment, the method comprises receiving the indication of the disposal of the waste item into the selected waste container in response to the current position matching the location of the selected waste container. However, the disposal of the waste item may be detected in any way according to the current position of the person (for example, when the current position of the person and the location of the selected waste container differ by less than any threshold, automatically, as a verification of a corresponding command entered manually by the person on the computing device, and so on).

In an embodiment, the method comprises storing an indication of a corresponding plurality of managing expenses for managing the waste disposed in the waste containers. However, the managing expenses may be stored in any way (for example, locally or remotely, per unit of weight, volume, and so on) and they may be determined in any way (for example, due to transport, treatment, recycling, reuse, dumping, and so on).

In an embodiment, the method comprises determining the suggested waste containers further according to the managing expenses of the waste containers. However, the suggested waste containers may be determined in any way according to the managing expenses (for example, by ranking the waste containers accordingly, filtering out the more expensive waste containers, and so on).

In an embodiment, the method comprises storing an indication of a corresponding plurality of emptying plans of the waste containers. However, the employing plans may be stored in any way (for example, locally or remotely, for any period of time, downloaded in advance, such as periodically or in response to any change, retrieved in real-time, and so on).

In an embodiment, the method comprises determining the suggested waste containers further according to the emptying plans of the waste containers. However, the suggested waste containers may be determined in any way according to the emptying plans (for example, by ranking the waste containers or filtering out the waste containers according to their filling indicators at the corresponding next emptying times, and so on).

In an embodiment, the method comprises ranking the suggested waste containers according to the waste item, the current position, the current filling indicators, and the context conditions. However, the suggested waste containers may be ranked in any way (for example, by giving same or different weights to the variables defining it, and so on).

In an embodiment, the method comprises returning the indication of the suggested waste containers according to said ranking thereof to the computing device. However, the suggested waste containers may be returned in any way according to their ranking (for example, by ordering or providing in succession the suggested waste containers accordingly, and so on).

In an embodiment, the method comprises determining one or more corresponding rewards for the person if disposing the waste item into the suggested waste containers according to said ranking thereof. However, the rewards may be of any type (for example, of partial, different and additional types with respect to the ones mentioned above, either individually or in any combination thereof).

In an embodiment, the method comprises returning the indication of the suggested waste containers in association with an indication of the corresponding rewards to the computing device. However, the rewards may be associated with the suggested waste containers in any way (for example, to cause their output on the computing device together with the corresponding suggested waste containers, to use them to highlight the suggested waste containers accordingly, such as in different colors, and so on).

Generally, similar considerations apply if the same solution is implemented with an equivalent method (by using similar steps with the same functions of more steps or portions thereof, removing some non-essential steps or adding further optional steps); moreover, the steps may be performed in a different order, concurrently or in an interleaved way (at least in part).

An embodiment provides a computer program that is configured for causing a computing system to perform the above-mentioned method. An embodiment provides a computer program product, which comprises one or more computer readable storage media that have program instructions collectively stored thereon; the program instructions are readable by a computing system to cause the computing system to perform the same method. However, the computer program may be implemented as a stand-alone module, as a plug-in for a pre-existing software application (for example, a legacy waste management application) or directly therein. Moreover, the computer program may be executed on any computing system (see below). In any case, the solution according to an embodiment of the present invention lends itself to be implemented even with a hardware structure (for example, by electronic circuits integrated in one or more chips of semiconductor material), or with a combination of software and hardware suitably programmed or otherwise configured.

An embodiment provides a computer system comprising means that are configured for performing the steps of the above-described method. An embodiment provides a computer system comprising a circuit (i.e., any hardware suitably configured, for example, by software) for performing each step of the above-described method. However, the system may comprise any number and type of computing machines (for example, of physical and/or virtual type) and it may have any architecture (stand-alone, distributed with the computing machines communicating among them via any network, implemented in a cloud environment, and so on).

Generally, similar considerations apply if the system has a different structure or comprises equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for managing waste, the computer-implemented method comprises:
receiving, by one or more processors, a corresponding plurality of current filling indicators of a plurality of waste containers from a corresponding plurality of sensing devices associated with the plurality of waste containers;
providing, by the one or more processors, a first indication of one or more context conditions relating to the plurality of waste containers;
receiving, by the one or more processors, a second indication of at least one waste item to be disposed by a person from a computing device of the person;
providing, by the one or more processors, a third indication of a current position of the person;
determining, by the one or more processors, one or more suggested waste containers of the plurality of waste containers for disposing the at least one waste item according to the at least one waste item, the current position, the corresponding plurality of current filling indicators, and the one or more context conditions; and
returning, by the one or more processors, a fourth indication of the one or more suggested waste containers to the computing device to cause an output thereof on the computing device.

2. The computer-implemented method of claim 1, further comprising:
receiving, by the one or more processors, a schedule of one or more mass events; and
defining, by the one or more processors, the one or more context conditions according to the one or more mass events.

3. The computer-implemented method of claim 1, further comprising:
storing, by the one or more processors, one or more previous filling indicators of each of the plurality of waste containers;
determining, by the one or more processors, a corresponding plurality of normal filling indicators of the plurality of waste containers according to the corresponding one or more previous filling indicators;
determining, by the one or more processors, corresponding first filling increases of the plurality of waste containers being impacted by each active one of the one or more context conditions according to a comparison between the corresponding plurality of current filling indicators and the plurality of normal filling indicators;
storing, by the one or more processors, the first filling increases of the plurality of waste containers being impacted of each previous one of the one or more context conditions;
estimating, by the one or more processors, corresponding second filling increases of the plurality of waste containers to be impacted by each forthcoming one of the one or more context conditions according to first filling increases of the plurality of waste containers impacted by each previous one of the one or more context conditions; and
determining, by the one or more processors, the suggested one or more waste containers according to the plurality of current filling indicators of the plurality of waste containers being updated according to the second filling increases of the plurality of waste containers to be impacted by the forthcoming context conditions.

4. The computer-implemented method of claim 1, further comprising:
providing, by the one or more processors, a current route of the person; and
determining, by the one or more processors, the suggested one or more waste containers further according to the current route.

5. The computer-implemented method of claim 4, further comprising:
receiving, by the one or more processors, the current route from a navigation application of the computing device.

6. The computer-implemented method of claim 4, further comprising:
storing, by the one or more processors, a plurality of previous positions of the person;
determining, by the one or more processors, one or more recurrent routes of the person according to the plurality of previous positions; and
estimating, by the one or more processors, the current route according to the one or more recurrent routes.

7. The computer-implemented method of claim 1, further comprising:
storing, by the one or more processors, a profile of the person; and
determining, by the one or more processors, the suggested one or more waste containers further according to the profile.

8. The computer-implemented method of claim 7, further comprising:
receiving, by the one or more processors, a fifth indication of a disposal of the waste item into a selected waste container of the suggested one or more waste containers from the computing device; and
updating, by the one or more processors, the profile according to the disposal of the waste item.

9. The computer-implemented method of claim 8, further comprising:
receiving, by the one or more processors, the fifth indication of the disposal of the waste item into the selected waste container in response to the current position matching the location of the selected waste container.

10. The computer-implemented method of claim 1, further comprising:
storing, by the one or more processors, a fifth indication of a corresponding plurality of managing expenses for managing the waste disposed in the plurality of waste containers; and
determining, by the one or more processors, the suggested one or more waste containers further according to the managing expenses of the plurality of waste containers.

11. The computer-implemented method of claim 1, further comprising:
storing, by the one or more processors, a fifth indication of a corresponding plurality of emptying plans of the plurality of waste containers; and
determining, by the one or more processors, the suggested one or more waste containers further according to the plurality of emptying plans of the plurality of waste containers.

12. The computer-implemented method of claim 1, further comprising:
ranking, by the one or more processors, the suggested one or more waste containers according to the waste item, the current position, the plurality of current filling indicators, and the context conditions; and
returning, by the one or more processors, the fourth indication of the suggested one or more waste containers according to said ranking thereof to the computing device.

13. The computer-implemented method of claim 12, further comprising:
determining, by the one or more processors, one or more corresponding rewards for the person if disposing the waste item into the suggested one or more waste containers according to said ranking thereof; and
returning, by the one or more processors, the fourth indication of the suggested one or more waste containers in association with a fifth indication of the corresponding rewards to the computing device.

14. A computer program product for managing waste, the computer program product comprising:
one or more computer readable storage media having program instructions collectively stored on said one or more computer readable storage media, the program instructions readable by a computing system to cause the computing system to perform a method comprising:
receiving a corresponding plurality of current filling indicators of a plurality of waste containers from a corresponding plurality of sensing devices associated with the plurality of waste containers;
providing a first indication of one or more context conditions relating to the plurality of waste containers;
receiving a second indication of at least one waste item to be disposed by a person from a computing device of the person;
providing a third indication of a current position of the person;
determining one or more suggested waste containers of the plurality of waste containers for disposing the at least one waste item according to the at least one waste item, the current position, the corresponding plurality of current filling indicators, and the one or more context conditions; and
returning a fourth indication of the one or more suggested waste containers to the computing device to cause an output thereof on the computing device.

15. The computer program product of claim 14, the program instructions readable by the computing system to cause the computing system to perform the method further comprising:
storing a fifth indication of a corresponding plurality of emptying plans of the plurality of waste containers; and
determining the suggested one or more waste containers further according to the plurality of emptying plans of the plurality of waste containers.

16. The computer program product of claim 14, the program instructions readable by the computing system to cause the computing system to perform the method further comprising:
ranking the suggested one or more waste containers according to the waste item, the current position, the plurality of current filling indicators, and the context conditions; and
returning the fourth indication of the suggested one or more waste containers according to said ranking thereof to the computing device.

17. The computer program product of claim 16, the program instructions readable by the computing system to cause the computing system to perform the method further comprising:
determining, by the one or more processors, one or more corresponding rewards for the person if disposing the waste item into the suggested one or more waste containers according to said ranking thereof; and
returning, by the one or more processors, the fourth indication of the suggested one or more waste containers in association with a fifth indication of the corresponding rewards to the computing device.

18. A computer system for managing waste, the computer system comprising:
one or more computer processors;
one or more computer readable storage media;
program instructions stored on the computer readable storage media for execution by at least one of the one or more processors, the program instructions comprising:
program instructions to receive a corresponding plurality of current filling indicators of a plurality of waste containers from a corresponding plurality of sensing devices associated with the plurality of waste containers;
program instructions to provide a first indication of one or more context conditions relating to the plurality of waste containers;
program instructions to receive a second indication of at least one waste item to be disposed by a person from a computing device of the person;
program instructions to provide a third indication of a current position of the person;
program instructions to determine one or more suggested waste containers of the plurality of waste containers for disposing the at least one waste item according to the at least one waste item, the current position, the corresponding plurality of current filling indicators, and the one or more context conditions; and
program instructions to return a fourth indication of the one or more suggested waste containers to the computing device to cause an output thereof on the computing device.

19. The computer system of claim 18, further comprising:
program instructions to rank the suggested one or more waste containers according to the waste item, the current position, the plurality of current filling indicators, and the context conditions; and
program instructions to return the fourth indication of the suggested one or more waste containers according to said ranking thereof to the computing device.

20. The computer system of claim 19, further comprising:
program instructions to determine one or more corresponding rewards for the person if disposing the waste item into the suggested one or more waste containers according to said ranking thereof; and
program instructions to return the fourth indication of the suggested one or more waste containers in association with a fifth indication of the corresponding rewards to the computing device.
